(19) United States
(12) Patent Application Publication
(10) Pub. No.: US 2021/0406797 A1
(43) Pub. Date: Dec. 30, 2021

(54) CONTACTLESS DRIVE THROUGH FACILITY HAVING AN ORDER MANAGEMENT SYSTEM

(71) Applicant: Everseen Limited, Blackpool (IE)

(72) Inventors: Vasile Gui, Timisoara (RO); Ciprian David, Timisoara (RO); Dan Alexandru Pescaru, Timisoara (RO); Alan O'Herlihy, Glenville (IE); Joe Allen, Ballybunion (IE)

(21) Appl. No.: 17/352,446

(22) Filed: Jun. 21, 2021

Related U.S. Application Data
(60) Provisional application No. 63/043,811, filed on Jun. 25, 2020.

(51) Int. Cl. G06Q 10/06; G06Q 50/28; G06Q 20/20; G06Q 30/06; G05B 19/4155; G06K 9/00; B65G 17/20; B65G 17/36; B65G 35/00; G08G 1/04

(52) U.S. Cl. CPC G06Q 10/06315; G06Q 50/28; G06Q 20/204; G06Q 30/0633; G05B 19/4155; B65G 2811/091; B65G 17/20; B65G 17/36; B65G 35/00; G08G 1/04; G05B 2219/41326; G06K 9/00791

(57) ABSTRACT

A contactless drive through facility includes a set of parking bays aligned substantially in parallel, wherein each parking bay is dimensioned to accommodate a customer vehicle therein. The drive through facility further includes first and second overhead wires traversing the set of parking bays, wherein the first and second overhead wires are spaced apart from each other. The drive through facility further includes a set of order processing units moveably suspended from the first overhead wire and a carrier member moveably suspended from the second overhead wire. The drive through facility further includes an order management system to operate each order processing unit for facilitating an order placing process and a payment process by corresponding customer vehicle. The order management system also operates the carrier member for moving a set of delivery containers fulfilling corresponding ones of one or more orders placed using the set of order processing units.

### CROSS-REFERENCE TO RELATED APPLICATION(S)

This application claims the benefit of U.S. Provisional Application Ser. No. 63/043,811, filed Jun. 25, 2020, the entire contents of which are hereby incorporated by reference.

### TECHNICAL FIELD

The present disclosure relates generally to a drive through facility, and more specifically to a contactless drive through facility having an order management system.

### BACKGROUND

Drive through facilities such as drive through restaurants and drive through retail facilities are well-known. In the wake of Covid-19, social distancing restrictions may increase the demand for drive through facilities as indoor retail/dining becomes more difficult. A conventional drive through facility requires vehicles to queue in dedicated service lanes and customers to sit in the vehicles awaiting their turn to place their orders and retrieve ordered goods. However, a throughput capacity of these lanes may be limited by the time taken by individual customers to place their orders, pay for their orders and for the orders to be fulfilled. The increased use of drive through facilities may perhaps also mean that customer queues may get longer than usual. To prevent customers from being deterred by such long queues, operators of drive through facilities must increase their throughput capacity. However, options for improving the throughput capacity are currently limited by infrastructure that is typically used in operation of such conventional drive through facilities.

In addition, while most of the infrastructure in a conventional drive-through facility may support the isolation of individual customers from each other, the customer interaction aspects of such facilities remain largely human-driven. In many cases, these interactions may also occur at close distances and therefore, do not comply with pandemic driven safety protocols. Specifically, conventional drive through facilities use customer vehicles and their ordered progression along a service lane to effectively isolate customers from each other. However, while placing an order, paying for the order and/or retrieving one or more items pertaining to the placed order from a repository, for example, a service kiosk within the drive through facility, customers may need to come close to and interact with staff members of the drive through facility. In other words, conventional drive through facilities offer incomplete social isolation in so far, as they offer little isolation of customers from staff members.

### SUMMARY

In an aspect of the present disclosure, a contactless drive through facility includes a set of parking bays aligned substantially in parallel, wherein each parking bay is dimensioned to accommodate a customer vehicle therein. The contactless drive through facility further includes first and second overhead wires traversing the set of parking bays, wherein the first and second overhead wires are spaced apart from each other. The contactless drive through facility further includes a set of order processing units moveably suspended from the first overhead wire and a carrier member moveably suspended from the second overhead wire. The contactless drive through facility further includes an order management system that is configured to operate each order processing unit from the set of order processing units for facilitating an order placing process and a payment process by corresponding customer vehicle. The order management system is also configured to operate the carrier member for moving a set of delivery containers fulfilling corresponding ones of one or more orders placed using the set of order processing units.

In another aspect of the present disclosure, a method for providing and operating a drive through facility for ordering and retrieving goods in a contactless manner is provided. The method includes providing a set of parking bays aligned substantially in parallel, wherein each parking bay is dimensioned to accommodate a customer vehicle therein. The method further includes providing first and second overhead wires traversing the set of parking bays, wherein the first and second overhead wires are spaced apart from each other. The method further includes providing a set of order processing units moveably suspended from the first overhead wire. The method further includes providing a carrier member moveably suspended from the second overhead wire. The method further includes providing an order management system that is configured to operate each order processing unit from the set of order processing units for facilitating an order placing process and a payment process by corresponding customer vehicle and the carrier member for moving a set of delivery containers fulfilling corresponding ones of one or more orders placed using the set of order processing units.

In yet another aspect, the present disclosure provides a non-transitory computer readable medium having computer-executable instructions stored thereon. These computer-executable instructions when executed by a processor cause the processor to detect a parking of a customer vehicle in a parking bay, detect a location, including elevation, of a driver, or passenger, side window of the customer vehicle with reference to identifiers of a video camera that captured an image frame of the customer vehicle and the location of the vehicle within the image frame, move an order processing unit to the driver, or passenger, side window of the customer vehicle based on the detected location, receive an order from an occupant of the customer vehicle by the order processing unit, request the occupant of the vehicle to make payment to the order processing unit for a calculated total bill for the received order, receive payment for the calculated total bill from the occupant of the vehicle by the order processing unit, transmit details of the received order from the order processing unit to an order management system for preparing one or more goods, or items, and deliver the one or more goods, or items, to a loading area, load a carrier member with the one or more goods, or items, corresponding to one or more received orders at the loading area, move the carrier member to a location of a closest customer vehicle from which one of the orders was received, lower the one or more goods, or items, using a delivery container corresponding to the received order to a driver, or passenger, side window of the customer vehicle, detect retrieval of the delivery container by the occupants of the closest customer vehicle, move the carrier member to a location of a subsequent customer vehicle from which a subsequent order was received, and return the carrier member to the loading area on delivering the delivery containers to each customer vehicle from which the subsequent order was received.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates a diagrammatic overhead view of a contactless drive through facility having an order management system for ordering and retrieving goods in a contactless manner, in accordance with an embodiment of the present disclosure.

FIG. 2 illustrates a diagrammatic front view of the drive through facility, in accordance with a first embodiment of the present disclosure;

FIG. 3 illustrates a diagrammatic front view of the drive through facility, in accordance with a second embodiment of the present disclosure;

FIG. 4 is a schematic representation of motors and controllers that can be implemented for use and operation by a carrier member of the drive through facility of FIGS. 2 and 3 respectively, in accordance with an embodiment of the present disclosure;

FIG. 5 is a flowchart of a method showing steps to provide the contactless system for ordering and retrieving goods in the drive through facility; and

FIG. 6 is a low-level implementation of functions that are performed by an order processing unit and the carrier member of the drive through facility, in accordance with an illustrative embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

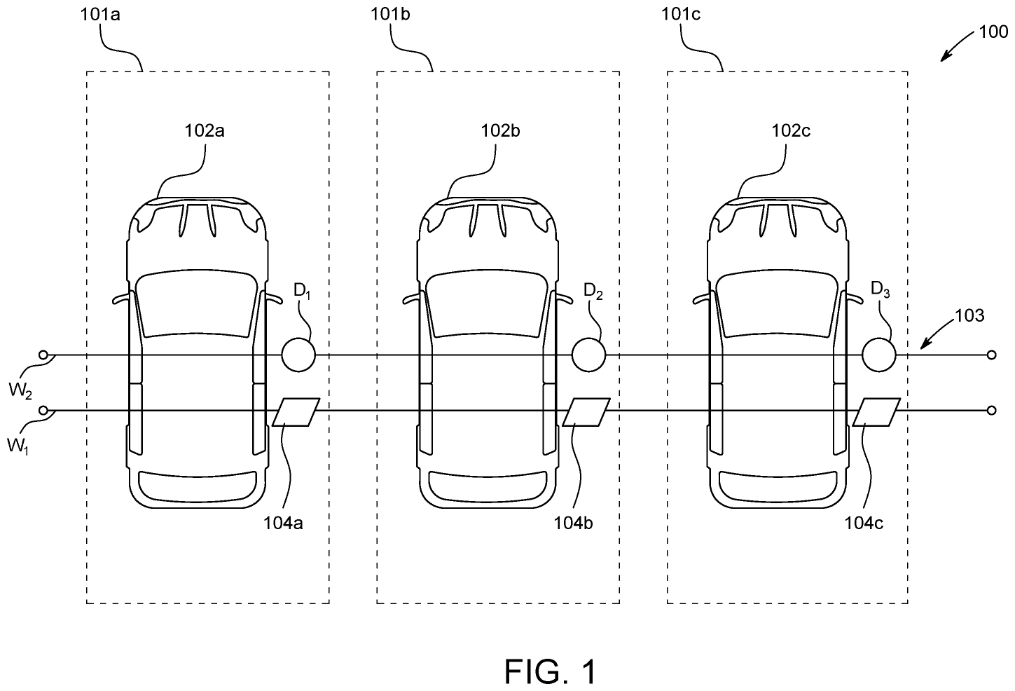

FIG. 1 illustrates a diagrammatic overhead view of a contactless drive through facility 100 having an order management system 103 for ordering and retrieving goods in a contactless manner, in accordance with an embodiment of the present disclosure. The contactless drive through facility 100 includes first through third parking bays 101a, 101b, and 101c (hereinafter collectively referred to as the parking bays 101) aligned substantially in parallel. Each of the parking bays 101 is dimensioned to accommodate first through third customer vehicles 102a, 102b, and 102c (hereinafter collectively referred to as customer vehicles 102) respectively. In use, each of the customer vehicles 102 may, preferably, be directed to park with the same orientations in corresponding ones of the parking bays 101. In an example, front sides of all the customer vehicles 102 face the same direction. For brevity, each parking bay 101 may be hereinafter referred to as the customer parking bay, and the group of parking bays of which the customer parking bay is a member may be herein referred to as the designated parking bay group.

Although, three parking bays are illustrated herein for brevity, it would be apparent to one of ordinary skill in the art, that there may be more than three parking bays in one of many designated parking bay groups in the contactless drive through facility 100 (hereinafter referred to as the drive through facility 100). In addition, other designated parking bay groups may be similarly or dissimilarly oriented, for example, in an orientation angular, or perpendicular, to the designated parking bay group shown in the view of FIG. 1. Moreover, such other designated parking bay groups may be contiguous, for example, in a continuous polyline, or curvilinear, manner or as discrete groups of parking bays in relation to the designated parking bay group shown in the view of FIG. 1. It may be noted that a scope of the present disclosure, and particularly that of, the order management system 103 can be extended to similarly, or equally, be applied for implementation and operation when such configurations of parking bay groups are additionally, or optionally, encountered within the drive through facility 100.

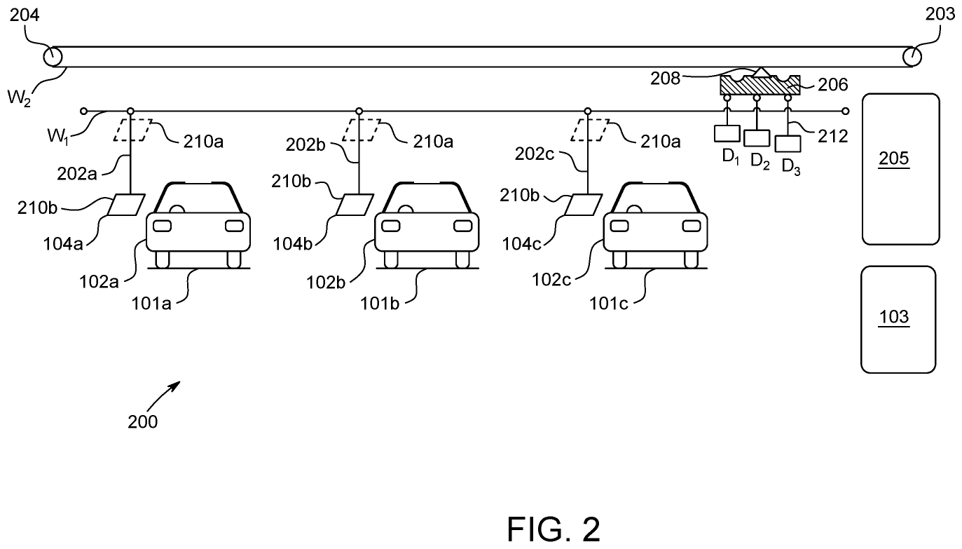

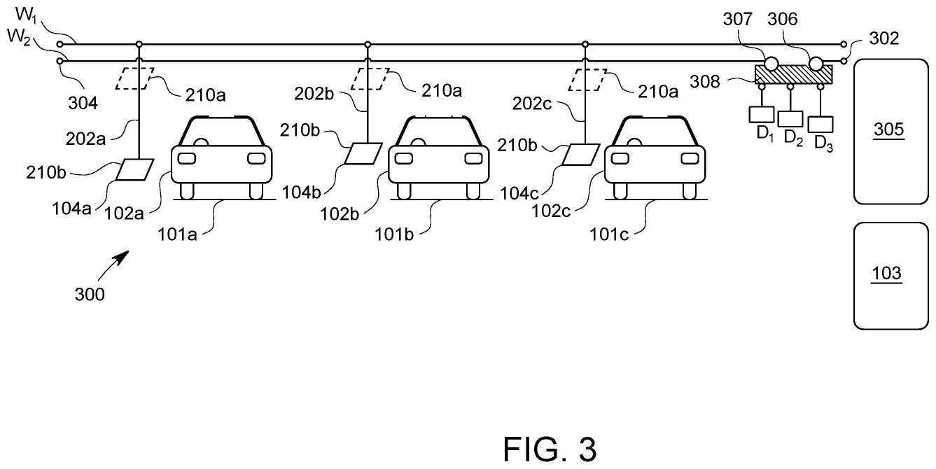

The drive through facility 100 includes two overhead wires W₁ and W₂ traversing the parking bays 101. The two overhead wires W₁ and W₂ are spaced apart from each other. For sake of distinction, the overhead wire W₁ will hereinafter be referred to as ‘the first overhead wire’ and denoted using identical reference ‘W₁’. Similarly, the overhead wire W₂ will hereinafter be referred to as ‘the second overhead wire’ and denoted using identical reference ‘W₂’. The first and second overhead wires may be substantially co-planar in that they may be parallel to one another but lie in a single plane, i.e., the first and second overhead wires may be horizontally offset from one another, vertically offset from one another, or both in which the first and second overhead wires have a lateral distance between them but are also spaced apart to have different elevations from each other as shown in the diagrammatic front views of first and second embodiments of drive through facilities 200, 300 as shown in FIGS. 2 and 3 respectively. As such, FIG. 2 illustrates a front view of the contactless drive through facility 200, in accordance with a first embodiment of the present disclosure. Moreover, FIG. 3 illustrates a front view of the contactless drive through facility 300, in accordance with a second embodiment of the present disclosure.

The drive through facility 100 also includes a set of order processing units 104a, 104b, 104c moveably suspended from the first overhead wire W₁. In an exemplary configuration shown in FIGS. 1-3, first through third order processing units 104a till 104c (hereinafter collectively referred to as the order processing units 104) are moveably suspended from the first overhead wire W₁. Moreover, as shown in FIG. 2, the drive through facility includes a carrier member 206 that is moveably suspended from the second overhead wire W₂ while in FIG. 3, a carrier member 308 is shown moveably suspended from the second overhead wire W₂. In the embodiment of FIGS. 2 and 3, the second overhead wire W₂ is shown the second overhead wire extends between two electrical stepper motors disposed at two fixed locations spanning, at least, a combined width of the set of parking bays 101. In the embodiment of FIG. 2, the second overhead wire W₂ is embodied in the form of a conveyor belt type of arrangement to form a loop between the two electrical stepper motors disposed at the two fixed locations spanning, at least, the combined width of the set of parking bays 101. In the embodiment of FIG. 3, the second overhead wire W₂ is formed using a pair of non-looped open ended wire segments, and wherein the carrier member 308 is provided with two electrical stepper motors such that the ends of each non-looped open ended wire segment are arranged to couple one electrical stepper motor disposed at one of the two fixed locations with a proximal one of the electrical stepper motors 306, 307 of the carrier member 308.

The order management system 103 is configured to operate each order processing unit 104a, 104b and 104c from the set of order processing units 104 for facilitating an order placing process and a payment process by corresponding customer vehicle. Further, the order management system 103 is also configured to operate the carrier member 206/308 for moving a set of delivery containers fulfilling corresponding ones of one or more orders placed using the set of order processing units 104.

In an embodiment of the present disclosure, each of the order processing units 104 may include a display unit (not shown) and a contactless card reader (not shown) in communication with each other. The display unit and a contactless card reader may be physically separate but functionally linked units residing within, or on, each of the order processing units 104.

In the illustrated embodiment of FIGS. 1-3, the second overhead wire W₂ may be dedicated to making first through third deliveries using delivery containers D₁, D₂, D₃ of good(s)/item(s) that are ordered through the first through third order processing units 104a till 104c to the customer vehicles 102a till 102c.

In accordance with an embodiment of the present disclosure, as shown in FIG. 2, the order processing units 104 are suspended from the first overhead wire W₁ by first through third primary hanging wires 202a till 202c (hereinafter collectively referred to as primary hanging wires 202). The primary hanging wires 202 are disposed in a spaced apart arrangement, so that the processing units 104 are aligned with corresponding ones of the parking bays 101, and more specifically, with a driver (or passenger) side window of corresponding customer vehicles 102 when parked in respective ones of the parking bays 101. In an embodiment of the present disclosure, each of the primary hanging wires 202 is coupled with the first overhead wire W₁ by an electrical stepper motor which includes a rotor (not shown).

In an embodiment of the present disclosure, the rotor of the electrical stepper motor is coupled with a first end of each of the primary hanging wires 202 and is arranged so that at least a portion of each primary hanging wire 202 proximal to the first end is partly wrapped around the rotor. Each of the order processing units 104 is vertically movable between a first elevation 210a and a second elevation 210b through the activation of the electrical stepper motor to cause corresponding ones of the primary hanging wires 202 to be wound, or unwound, from the electric motor rotor, thereby shortening, or lengthening, corresponding ones of the primary hanging wires 202. In this way, the order processing units 104 may be raised or lowered to different heights i.e., elevation 210a to elevation 210b from a ground to suit heights of the driver, or passenger window, present in different types of customer vehicles 102, for example, a sedan, a jeep, a truck and other types of vehicles commonly known in the art. In an embodiment of the present disclosure, each of the order processing units 104 may be provided with one or more video cameras, object recognition algorithms, or proximity sensors to detect the presence of the customer vehicle in the parking bay 101 so that the order management system 103 may align the order processing units 104 with the customer, or passenger, side window of the corresponding customer vehicle 102.

In an example, upon detecting the presence of the first customer vehicle 102a using data received from its on-board cameras, the first order processing unit 104a is configured to be autonomously raised or lowered to achieve an elevation level with corresponding driver/passenger window. In this way, a display unit of the first order processing unit 104a is positioned at an appropriate height to allow the driver/passenger of the first customer vehicle 102a to view a menu of goods, or items, displayed on the display unit and select one or more goods, or items, therefrom for making, placing or establishing, the customer order. Upon receipt of the customer order, the first order processing unit 104a requests the customer to make contactless payment for the order through the contactless card reader in the first order processing unit 104a. The contactless card reader of the first order processing unit 104a is positioned at an appropriate height to allow a driver/passenger to present a payment card thereto and thereby enable payment to be made for ordered goods. Upon receipt of the customer order and payment, the details of the customer order together with an identifier of the first parking bay 101a are transmitted through a communications network to the order management system 103. The order management system 103 picks the one or more goods, or items, corresponding to the customer order from a repository, a kiosk, a restaurant, or a warehouse of the drive through facility 100, packs them into a corresponding one of the delivery containers D₁, D₂, or D₃ and transports the packed container D₁, D₂, or D₃ to a loading area 205.

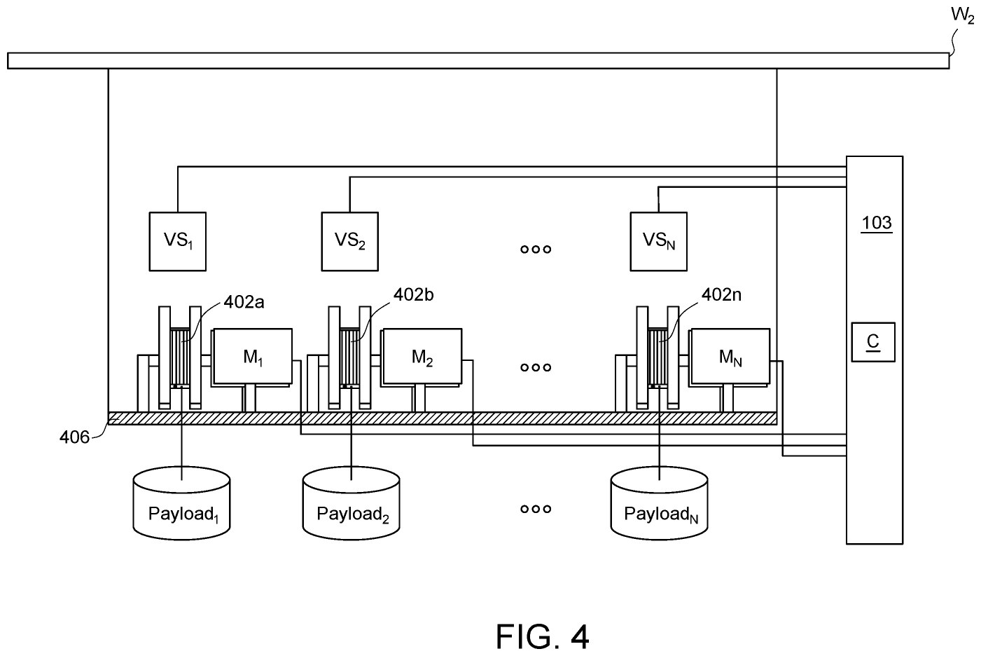

The order management system 103 of the present disclosure may include one or more processors, micro-processors, controllers (for example, controller C as shown in FIG. 4), micro-controllers, actuators and other system associated hardware for performing functions consistent with the present disclosure. In addition, the order management system 103 may also include appropriate software such as signal conditioning circuitry, machine learning algorithms, and other networking architecture for interfacing between the various system associated hardware components and driving operations of one or more components disclosed herein for independently and selectively moving each of the order processing units 104 and the carrier members 206, 308 (shown in FIGS. 2 and 3 respectively), the electrical stepper motors of the carrier member 206, 308 and other electrical stepper motors disclosed in the appended disclosure for causing movement of the order processing units 104 and the delivery containers D₁, D₂ and D₃ in relation to driver, or passenger, side window of the customer vehicles 102. The order management system 103 is also in communication with other system associated hardware including, but not limited to, video cameras, proximity sensors, or video sensors, for example, video sensors VS₁ to VS_{N} shown exemplarily in the view of FIG. 4.

As disclosed earlier herein, the second overhead wire W₂ is embodied in the conveyor belt type of arrangement wherein the second overhead wire W₂ forms the loop between the two electrical stepper motors (not shown) disposed at two fixed locations (see FIG. 2). As shown in FIG. 2, these two fixed locations having the two electrical stepper motors are denoted using reference numerals 203 and 204 respectively. The first location 203 is proximal to a loading area 205 and the second location 204 is proximal to a parking bay furthest, or farthest, from the loading area 205, for example, parking bay 101a as exemplarily shown in the view of FIG. 2. Each of the two electrical stepper motors includes a rotor (not shown) arranged so that the second overhead wire W₂ is looped around the rotors. The activation of the electrical stepper motors causes the rotation of the second overhead wire W₂ around the rotors.

In an embodiment of the present disclosure, a carrier member 206 is fixed to the second overhead wire W₂ by a gripping member 208, such that the rotation of the second overhead wire W₂ around the rotors (not shown) causes the carrier member 206 to be transported to and from the first and second locations 203 and 204, stopping as necessary at areas overhead intervening parking bays to perform fulfilment of the orders via the delivery of the containers D₁, D₂ and D₃ containing items, or goods, therein.

In an embodiment of the present disclosure, the carrier member 206 includes a plurality of electrical stepper motors (not shown) each of which comprises a rotor. Each rotor is coupled with a first end of a secondary hanging wire 212 and arranged so that at least a portion of the secondary hanging wire 212 proximal to the first end is partly wrapped around the rotor. The other end of the secondary hanging wire 212 is coupled with a corresponding delivery container, for instance, delivery container D₃ that may, for example, correspond to an order placed via the order processing unit 103. Thus, in this manner, each of the delivery containers D₁, D₂ and D₃ containing packed goods, or items, corresponding to the orders placed via order processing unit 103 may be effectively suspended from the carrier member 206 by corresponding secondary hanging wires 212.

Accordingly, in embodiments herein, the activation of an electrical stepper motor in the carrier member 206 causes the secondary hanging wire 212 coupled therewith to be further wound or unwound from the electrical stepper motor rotor, thereby shortening or lengthening the secondary hanging wire 212 to allow the delivery containers D₁, D₂ and D₃ containing packed good(s), or item(s), corresponding to the orders from respective ones of the order processing units 104 to be raised, or lowered, from i.e., in relation to the carrier member 206, as required. Moreover, in an embodiment of the present disclosure, in the loading area 205, each of the delivery containers D₁, D₂ and D₃ may be clipped onto, or otherwise coupled with, a corresponding one of the secondary hanging wires 212 suspended from the plurality of electrical stepper motors on the carrier member 206. When in transit between the loading area 205 and the customer vehicles 102, the secondary hanging wire 212 may be shortened to beneficially raise the delivery containers D₁, D₂, and D₃ close to the carrier member 206 to minimize the risk of the delivery containers D₁, D₂, and D₃ hitting obstacles en route to the passenger, or driver, side window of respective ones of the customer vehicles 102.

The carrier member 206 may move from the loading area 205 to the closest parking bay, for example, parking bay 101c from which an order was received, and stops at the customer vehicle 102c. The secondary hanging wire 212 is lengthened to the driver/passenger side window of the customer vehicle 102c until the delivery container D₃ is sufficiently, lowered, so as to be retrieved easily by an occupant i.e., driver, or the passenger of the customer vehicle 102c. The carrier member 206 then moves to the next parking bay, for example, parking bay 101b from which another order was received, and lowers the delivery container D₂ containing the items, or goods, corresponding to the order placed via the order processing unit 104b to the driver, or passenger, side window of the customer vehicle 102b until the container is retrieved by the occupant/customer i.e., driver/passenger of the customer vehicle 102b. In this way, the carrier member 206 moves to each parking bay from the set of parking bays 101 from which orders were received, to deliver the delivery containers, for example, containers D₁, D₂, D₃ to respective ones of the customer vehicles 102. On completion of the route, the order management system 103 also configures the carrier member 206 to be returned to the loading area 205 to be loaded with subsequent group of delivery containers (not shown).

As disclosed earlier herein, FIG. 3 illustrates a front view of the contactless drive through facility 300. in accordance with a second embodiment of the present disclosure. As shown in FIG. 3, in this embodiment, the contactless drive through facility 300 includes first and second fixed anchor points 302 and 304, respectively located proximal to a loading area 305 and proximal to the parking bay, for instance, parking bay 101a furthest, or farthest, from the loading area 305. In an embodiment of the present disclosure, the second overhead wire W₂ is divided into open, i.e. non-looped wire segments, wherein a first end 306 of a first wire segment is fixed to the first anchor point 302, and a first end 307 of a second wire segment is fixed to the second anchor point 304. In an embodiment of the present disclosure, two electrical stepper motors are provided at the first ends 306 and 307 in a manner such that they are mounted on an upper surface of the carrier member 308 (similar to the carrier member 206). Each of the two electrical stepper motors include a rotor (not shown) coupled with the first segment and the second segment of second overhead wire W₂, and arranged so that at least a portion of the first part of the second overhead wire W₂ proximal to a second end thereof is partly wrapped around the first rotor, and at least a portion of the second segment of the second overhead wire W₂ proximal to a second end thereof is partly wrapped around the second rotor. This may ensure that the non-looped first and second wire segments of the second overhead wire W₂ can be maintained taut at all times, particularly, when the carrier member 308 is loaded with the delivery containers, for example, delivery containers D₁, D₂ and/or D₃. As such, the activation of the electrical stepper motors causes the first segment and the second segment of the second overhead wire W₂ coupled to each electrical stepper motor to be further wound or unwound from the rotor of the corresponding electrical stepper motor to cause the carrier member 308 to be transported to any target location between the first and second locations 302 and 304, stopping as necessary at areas above i.e., overhead intervening parking bays 101.

FIG. 4 is a schematic representation of motors and controllers that can be implemented for use and operation by a carrier member of the drive through facility of FIGS. 2 and 3 respectively, in accordance with an embodiment of the present disclosure.

As shown, FIG. 4 illustrates first through N^{th} motors i.e., M₁ till M_{Nth} motors of the carrier member 406 (similar to the carrier member 206 shown in FIG. 2 or the carrier member 308 shown in FIG. 3). The motors M₁ till M_{N} are actuated and controlled by the controller C of the order management system 103 to carry several payloads, or packages, for example, Payload₁, Payload₂ . . . Payload_{N}, for instance, the delivery containers D₁ through D₃ that may be attached to hooks (not shown) at second ends of the secondary hanging wires 212 (see FIG. 2). These hooks, together with, the payloads attached thereon are transported by electrically controlled windlasses 402a, 402b and 402c. Each of these windlasses 402a, 402b and 402c may be embodied in the form of a motor operated winch assembly. For brevity, the electrically controlled windlass associated with a hook carrying a customer order may be hereinafter referred to as an order carrying windlass and denoted using identical reference numerals ‘402a’, ‘402b’ and ‘402c’ respectively.

The controller C is coupled in communication to each of the first through N^{th} i.e., M₁ till M_{Nth} motors and first through N^{th} video sensors VS₁ till VS_{Nth} mounted on the carrier member, for instance, carrier member 308. In an example, to transport a package to a first customer, the controller C causes the carrier member 308 to be moved until an image received from a first video sensor VS₁ located proximal to the order carrying windlass 402a for the first customer indicates that the carrier member 308 is aligned with the parking bay 101a in which the first customer vehicle 102a is parked, such that the order carrying windlass 402a is disposed proximal to the driver/passenger window of the first customer vehicle 101a. The controller C then activates a first motor M₁ for the order carrying windlass 402 to cause the payload (i.e., Payload₁) to descend to the first customer vehicle 101a.

In embodiments herein, video footage acquired by each of the video sensors, for example, the first video sensor VS₁ is processed by an ML-driven algorithm for monitoring the transfer of the payload (i.e., Payload₁) to the first customer. Once the payload has been retrieved by the first customer and the first customer is at safe distance from the hook (that previously carried the payload), the controller C in the order management system 103 activates the motor M₁ to raise the hook. Once the hook has been raised to a safe elevation above the customer vehicle(s) 101, the carrier member 308 is ready to progress to the next customer and deliver the relevant payload thereto.

In embodiments of the present disclosure, functions of the order processing unit 104 and the carrier member 206/308 of the order management system 103 may be performed using one or more controllers, for example, using the controller C shown in FIG. 4. Nevertheless, by implementing, distinctly, the processes of order taking and retrieving of the goods, or items, for order delivery using different devices (i.e., the order processing units and the carrier member) it is possible to eliminate, or at least minimize, the delays in order delivery that may have been previously incurred, for example, during the process of order taking itself. With implementation of these distinct processes on distinct devices, these processes may occur concurrently, simultaneously, in tandem, in parallel, or at least in quick succession with little to no delay whatsoever, so that customer vehicles 101 can drive away from the drive through facility 100, 200, or 300 and any queues and resultant wait times for prospective customers within the drive through facility 100, 200, or 300 can be minimized. Additionally, it is hereby further contemplated to modify the deliveries, or fulfillment of, orders according to a sequence in which the orders were received, rather than in accordance with a position of the vehicle from which the order was received, for instance, an order corresponding to the row-like arrangement of the parking bays 101. Such modifications can be easily contemplated by persons skilled in the art without deviating from a spirit of the present disclosure.

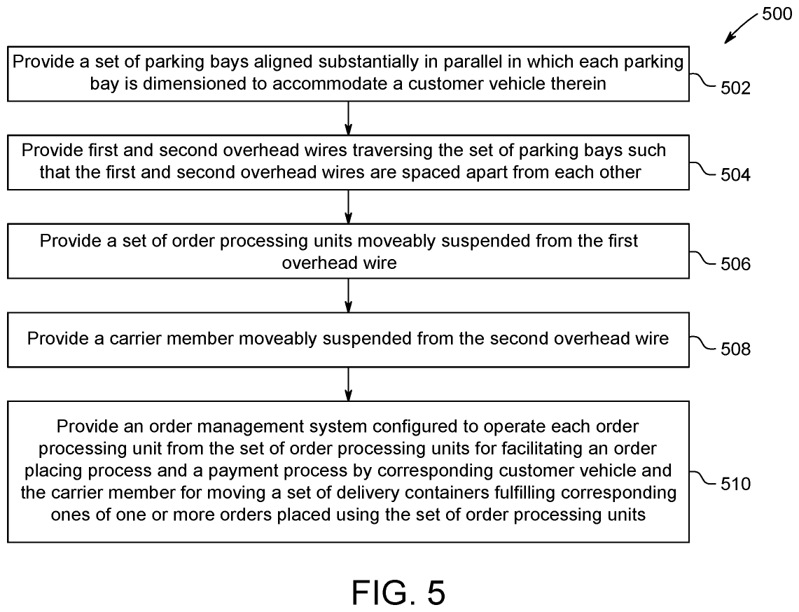

FIG. 5 is a flowchart of a method 500 showing steps 502-510 for providing and operating a drive through facility, for example, the drive through facility 100, 200, 300 for ordering and retrieving goods in a contactless manner, in accordance with an embodiment of the present disclosure.

As shown, at step 502, the method 500 includes providing the set of parking bays 101 aligned substantially in parallel, wherein each parking bay 101 is dimensioned to accommodate a customer vehicle 102 therein.

At step 504, the method 500 further includes providing first and second overhead wires W₁, W₂ traversing the set of parking bays 101, wherein the first and second overhead wires W₁, W₂ are spaced apart from each other.

At step 506, the method 500 further includes providing the set of order processing units 104 moveably suspended from the first overhead wire W₁.

At step 508, the method 500 further includes providing the carrier member 406 moveably suspended from the second overhead wire W₂.

At step 510, the method 500 further includes providing the order management system 103 that is configured to operate each order processing unit from the set of order processing units 104 for facilitating an order placing process and a payment process by occupants of a corresponding customer vehicle 102 and the carrier member 406 for moving the set of delivery containers for example, delivery containers D₁, D₂ and D₃ for fulfilling corresponding ones of one or more orders placed using the set of order processing units 104.

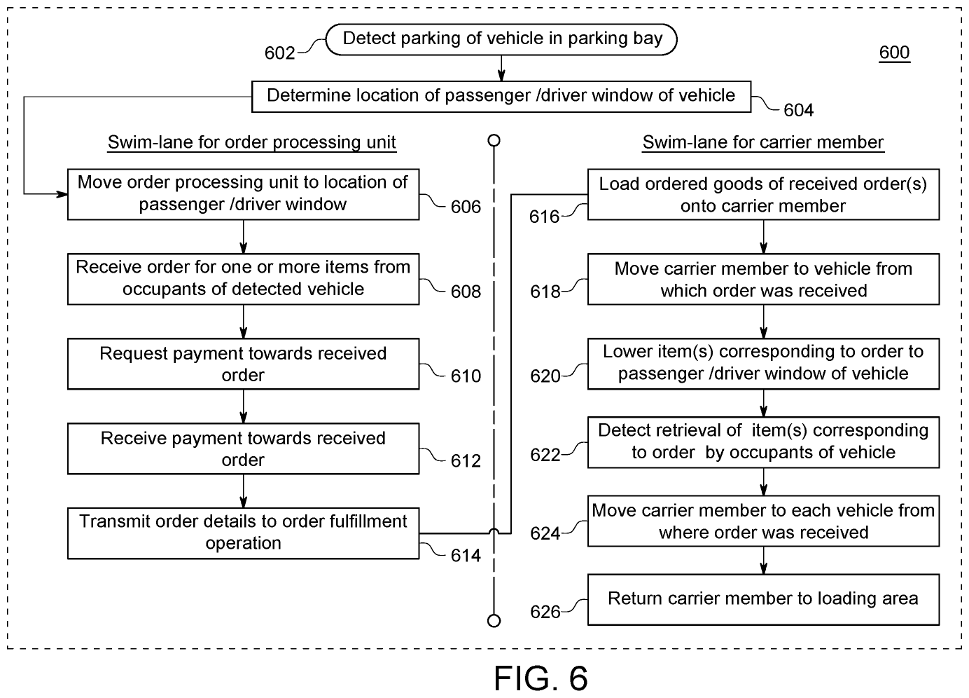

FIG. 6 is a low-level implementation 600 of functions that are performed by the order processing unit 104 and the carrier member 406 i.e., the carrier member 206, 308 of the drive through facility 200 or 300, in accordance with an illustrative embodiment of the present disclosure.

Referring to FIG. 6 in combination with FIGS. 1 to 4, in step 602, the parking of the customer vehicle 102 in the parking bay 101 is detected. The detection may be performed by video camera(s), proximity sensors etc., mounted on the order processing unit 104, the carrier member 206, 308 or elsewhere in the drive through facility 200, 300.

In step 604, a location, including the elevation, of a driver window or a passenger window of the customer vehicle 102 is detected with reference to an identifier of a video camera which captured an image/video frame of the vehicle 102 and the location of the vehicle 102 within the image/video frame. The determination of the location may be determined by an object detector deep neural network such as the EfficientDet (as described in M. Tan, R. Pang and Q. V. Le, EfficientDet: Scalable and Efficient Object Detection, 2020 IEEE/CVF Conference on Computer Vision and Pattern Recognition (CVPR) Seattle, Wash., USA, 2020, pp. 10778-10787) or by implementation of YOLOv4 (as described in A Bochkovskiy, C-Y Wang and H-Y M Liao, 2020 arXiv: 2004.10934). However, the skilled person will understand that these object detector deep neural network architectures are provided for example purposes only. In particular, the skilled person will understand that the method 500 of operating the drive through facility 100, 200, or 300 of the embodiments disclosed herein is not limited to implementation of these deep neural network architectures or the implementation of the exact order and type of steps disclosed in the low-level implementation 600 of the functions that are performed by the order processing unit 104 and the carrier member 406. In fact, on the contrary, the method 500 of operating the drive through facility 100, 200, or 300 is operable with any object detector architecture and/or training algorithm which is suitable for the detection, classification and localization of a vehicle in an image or video frame or concatenation of the same.

In step 606, the order processing unit 104 is moved to the determined location of the driver window or the passenger window of the customer vehicle 102.

In step 608, an order for good(s), or item(s), is received from the occupant(s) of the vehicle 102 by the order processing unit 104.

In step 610, the occupant(s) of the vehicle 102 are requested to make payment to the order processing unit 104 for a calculated total bill for the ordered good(s), or item(s).

In step 612, payment for the calculated total bill is received from the occupant(s) of the vehicle 102 by the order processing unit 104.

In step 614, the order processing unit 104 transmits details of the ordered good(s) via an order fulfilment operation (that is carried out by the order management system 103) to prepare, or otherwise assemble, the ordered good(s), or item(s) and deliver the ordered good(s) to the loading area 205.

In step 616, the carrier member 406 is loaded from the loading area 205 with delivery containers D₁, D₂, and D₃ containing the ordered good(s), or item(s) corresponding to each of the received orders.

In step 618, the carrier member 406 is moved to a location of a closest customer vehicle, for example, customer vehicle 102c from where one of the orders was received.

In step 620, the delivery container D₃ containing the ordered good(s), or item(s) of the corresponding received order are lowered to a driver/passenger window of the customer vehicle 102c.

In step 622, the retrieval of the ordered good(s), or item(s), by the occupants of the vehicle 102c is detected.

In step 624, the carrier member 206 is moved to the location of each vehicle from which another one of the orders was received. Steps 620 to 624 are repeated for each such customer vehicle 102 present in the parking bays 101. The order with which the carrier member 406 is moved to successive vehicles 102 from which an order was received may be determined by the respective distances of the vehicles 102 from the loading area 205.

In step 626, on delivering the ordered good(s) to each vehicle 102 from which an order was made, or placed, for the good(s), or item(s), the carrier member 206 is returned to the loading area 205.

In embodiments herein, functions corresponding to steps 602 to 626 may also reside on a non-transitory computer readable medium having computer-executable instructions stored thereon. These computer-executable instructions when executed by a processor, for example, the controller C of the order management system 103, can cause the processor to perform functions consistent with that of the low-level implementation 600 disclosed herein.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A contactless drive through facility comprising:
a set of parking bays aligned substantially in parallel, wherein each parking bay is dimensioned to accommodate a customer vehicle therein;
first and second overhead wires traversing the set of parking bays, wherein the first and second overhead wires are spaced apart from each other;
a set of order processing units moveably suspended from the first overhead wire;
a carrier member moveably suspended from the second overhead wire; and
an order management system configured to operate:
each order processing unit from the set of order processing units for facilitating an order placing process and a payment process by corresponding customer vehicle; and
the carrier member for moving a set of delivery containers fulfilling corresponding ones of one or more orders placed using the set of order processing units.

2. The contactless drive through facility of claim 1, wherein the set of order processing units are suspended from the first overhead wire through a corresponding set of primary hanging wires, wherein the primary hanging wires are disposed in a spaced apart arrangement so that the order processing units are aligned with a driver, or passenger, side window of a corresponding customer vehicle parked in a respective parking bay.

3. The contactless drive through facility of claim 1, wherein each of the order processing units is provided with one or more video cameras, object recognition algorithms, and proximity sensors for detecting a presence of the customer vehicle in respective ones of the parking bays aligned with corresponding ones of the order processing units.

4. The contactless drive through facility of claim 1, wherein the order management system is disposed in communication with one or more electrical stepper motors associated with each of the first and second overhead wires and the carrier member, wherein the order management system is configured to move each of the first and second overhead wires and the carrier member for moving the set of order processing units and the set of delivery containers via the carrier member relative to the customer vehicles.

5. The contactless drive through facility of claim 4, wherein the second overhead wire extends between two electrical stepper motors disposed at two fixed locations spanning a combined width of the set of parking bays.

6. The contactless drive through facility of claim 5, wherein the second overhead wire includes a conveyor belt type of arrangement forming a loop between the two electrical stepper motors disposed at the two fixed locations spanning the combined width of the set of parking bays.

7. The contactless drive through facility of claim 5, wherein the second overhead wire is formed using a pair of non-looped open ended wire segments, and wherein the carrier member is provided with two electrical stepper motors such that ends of each non-looped open ended wire segment is arranged to couple one electrical stepper motor disposed at one of the two fixed locations and a proximal one of the electrical stepper motors on the carrier member.

8. The contactless drive through facility of claim 5, wherein the carrier member further comprises a plurality of electrical stepper motors in communication with the order management system and coupled with first ends of corresponding ones of secondary hanging wires, the order management system configured to operably actuate the electrical stepper motors for moveably adjusting a height of each delivery container from the set of delivery containers suspended from second ends of corresponding ones of the secondary hanging wires to align respective ones of the delivery containers with a driver, or passenger, side window of a corresponding customer vehicle parked in a respective parking bay.

9. The contactless drive through facility of claim 4, wherein each order processing unit includes a display unit and a contactless card reader that are coupled in communication with each other, and wherein the order management system is configured to operate:
the display unit for facilitating the order placing process; and
the contactless card reader for facilitating the payment process.

10. A method for providing and operating a drive through facility for ordering and retrieving goods in a contactless manner, the method comprising:
providing a set of parking bays aligned substantially in parallel, wherein each parking bay is dimensioned to accommodate a customer vehicle therein;
providing first and second overhead wires traversing the set of parking bays, wherein the first and second overhead wires are spaced apart from each other;
providing a set of order processing units moveably suspended from the first overhead wire;
providing a carrier member moveably suspended from the second overhead wire; and
providing an order management system configured to operate:
each order processing unit from the set of order processing units for facilitating an order placing process and a payment process by corresponding customer vehicle; and
the carrier member for moving a set of delivery containers fulfilling corresponding ones of one or more orders placed using the set of order processing units.

11. The method of claim 10 further comprising:
suspending the set of order processing units from the first overhead wire through a corresponding set of primary hanging wires, and
disposing the primary hanging wires in a spaced apart arrangement so that the order processing units are aligned with a driver, or passenger, side window of a corresponding customer vehicle parked in a respective parking bay.

12. The method of claim 10 further comprising each of the order processing units with one or more video cameras, object recognition algorithms, and proximity sensors for detecting a presence of the customer vehicle in respective ones of the parking bays aligned with corresponding ones of the order processing units.

13. The method of claim 10 further comprising disposing the order management system in communication with one or more electrical stepper motors associated with each of the first and second overhead wires and the carrier member such that the order management system is configured to move each of the first and second overhead wires and the carrier member for moving the set of order processing units and the set of delivery containers via the carrier member relative to the customer vehicles.

14. The method of claim 13, wherein the second overhead wire extends between two electrical stepper motors disposed at two fixed locations spanning a combined width of the set of parking bays.

15. The method of claim 14 further comprising forming a loop between the two electrical stepper motors disposed at the two fixed locations spanning the combined width of the set of parking bays by embodying the second overhead wire as a conveyor belt type of arrangement.

16. The method of claim 14 further comprising:
forming the second overhead wire using a pair of non-looped open ended wire segments, and
providing the carrier member with two electrical stepper motors such that ends of each non-looped open ended wire segment is arranged to couple one electrical stepper motor disposed at one of the two fixed locations and a proximal one of the electrical stepper motors on the carrier member.

17. The method of claim 14 further comprising:
providing a plurality of electrical stepper motors to the carrier member in communication with the order management system; and
coupling rotors of the plurality of electrical stepper motors with first ends of corresponding ones of secondary hanging wires such that, in operation, the order management system is facilitated to operably actuate the electrical stepper motors for moveably adjusting a height of each delivery container from the set of delivery containers suspended from second ends of corresponding ones of the secondary hanging wires to align respective ones of the delivery containers with a driver, or passenger, side window of a corresponding customer vehicle parked in a respective parking bay.

18. The method of claim 13 further comprising:
providing each order processing unit with a display unit and a contactless card reader that is coupled in communication with the display unit, and
operating using the order management system:
the display unit for facilitating the order placing process; and
the contactless card reader for facilitating the payment process.

19. A non-transitory computer readable medium having stored thereon computer-executable instructions which, when executed by a processor, cause the processor to:
detect a parking of a customer vehicle in a parking bay;
detect a location, including elevation, of a driver, or passenger, side window of the customer vehicle with reference to identifiers of a video camera that captured an image frame of the customer vehicle and the location of the customer vehicle within the image frame;
move an order processing unit to the driver, or passenger, side window of the customer vehicle based on the detected location;
receive an order from an occupant of the customer vehicle by the order processing unit;
request the occupant of the customer vehicle to make payment to the order processing unit for a calculated total bill for the received order;
receive payment for the calculated total bill from the occupant of the customer vehicle by the order processing unit;
transmit details of the received order from the order processing unit to an order management system for preparing one or more goods, or items, and deliver the one or more goods, or items, to a loading area;
load a carrier member with the one or more goods, or items, corresponding to one or more received orders at the loading area;
move the carrier member to a location of a closest customer vehicle from which one of the orders was received;
lower the one or more goods, or items, using a delivery container corresponding to the received order to a driver, or passenger, side window of the customer vehicle;
detect retrieval of the delivery container by the occupants of the closest customer vehicle;
move the carrier member to a location of a subsequent customer vehicle from which a subsequent order was received; and
return the carrier member to the loading area on delivering the delivery containers to each customer vehicle from which the subsequent order was received.
